(19) United States
(12) Patent Application Publication
(10) Pub. No.: US 2009/0151904 A1
(43) Pub. Date: Jun. 18, 2009

(54) HEATING DEVICE

(76) Inventor: Steven Yue, Taipei City (TW)

Correspondence Address: PERMAN & GREEN, 425 POST ROAD, FAIRFIELD, CT, 06824, US

(21) Appl. No.: 12/207,538

(22) Filed: Sep. 10, 2008

Related U.S. Application Data
(63) Continuation of application No. 11/957,791, filed on Dec. 17, 2007.

(51) Int. Cl. F28F 21/00; F28F 1/10; G05D 23/00

(52) U.S. Cl. 165/104.21; 165/181; 165/287

(57) ABSTRACT

A heating device includes a heat-conductive tube unit adapted for passage of a heated fluid therethrough and having two opposite end portions and a middle portion extending between the end portions, a phase-change material enclosing the middle portion of the heat-conductive tube unit and that is capable of storing heat through phase changing, and an enclosure enclosing the phase-change material for preventing leakage of the phase-change material.

### CROSS-REFERENCE TO RELATED APPLICATION

This application is a continuation-in-part (CIP) of commonly owned co-pending U.S. patent application Ser. No. 11/957,791, filed on Dec. 17, 2007.

### BACKGROUND OF THE INVENTION

1. Field of the Invention

This invention relates to a heating device, more particularly to a heating device including a phase-change material and that can be arranged by bending thereof so as to optimize heat-release distribution.

2. Description of the Related Art

Referring to FIG. 1, a conventional heating device 100, commonly known as a “hand warmer,” comprises a pocket 7 that is filled with a phase-change material 70. Before the user can use the hand warmer 100, the user must pre-heat the hand warmer 100 using an external device or means, such as by putting the hand warmer 100 in hot water or by using a microwave oven, so that the phase-change material 70 is heated. As a result, the phase-change material 70 undergoes phase change and therefore, is able to better store heat.

In commonly owned co-pending U.S. patent application Ser. No. 11/957,791, there is disclosed a heating device including an electrically conductive heating wire unit having two opposite end portions and a middle portion extending between the end portions, a phase-change material enclosing the middle portion of the heating wire unit and that is capable of storing heat through phase changing, and an enclosure enclosing the phase-change material for preventing leakage of the phase-change material. The entire disclosure of the commonly owned co-pending U.S. patent application is incorporated herein by reference.

### SUMMARY OF THE INVENTION

An object of the present invention is to provide a heating device that can be arranged by bending thereof so as to optimize heat-release distribution and that can be used to provide heat for long periods of time.

According to the present invention, a heating device includes a heat-conductive tube unit adapted for passage of a heated fluid therethrough and having two opposite end portions and a middle portion extending between the end portions, a phase-change material enclosing the middle portion of the heat-conductive tube unit and capable of storing heat through phase changing, and an enclosure enclosing the phase-change material for preventing leakage of the phase-change material.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional heating device;

FIG. 2 is an exploded perspective view of a heating device according to the first preferred embodiment of the present invention;

FIG. 3 is a schematic view of the heating device of the first preferred embodiment, illustrating an example of how the heating device can be arranged in a specific configuration by bending;

FIG. 4 is a fragmentary side view of the first preferred embodiment, illustrating a temperature sensor disposed on an enclosure of the heating device;

FIG. 5 is a cross-sectional view of a modified example of the heating device of the first preferred embodiment, illustrating a tube support in the enclosure of the heating device;

FIG. 6 is an exploded perspective view of another modified example of the first preferred embodiment of the heating device in accordance with the present invention;

FIG. 7 is an exploded perspective view of yet another modified example of the heating device of the first preferred embodiment, illustrating a coil-shaped heat-conductive tube with a plurality of fins thereon;

FIG. 8 is a cross-sectional view of the second preferred embodiment of the heating device in accordance with the present invention; and

FIG. 9 is a schematic view of the second preferred embodiment, illustrating an exemplary layout of the heating device.

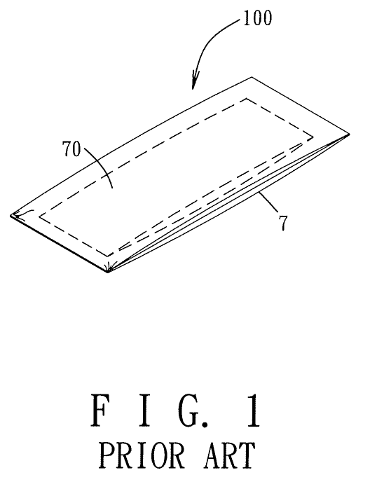

### DETAILED DESCRIPTION OF THE PREFERRED EMBODIMENTS

Before the present invention is described in greater detail with reference to the preferred embodiments, it should be noted herein that like elements are denoted by the same reference numerals throughout the disclosure.

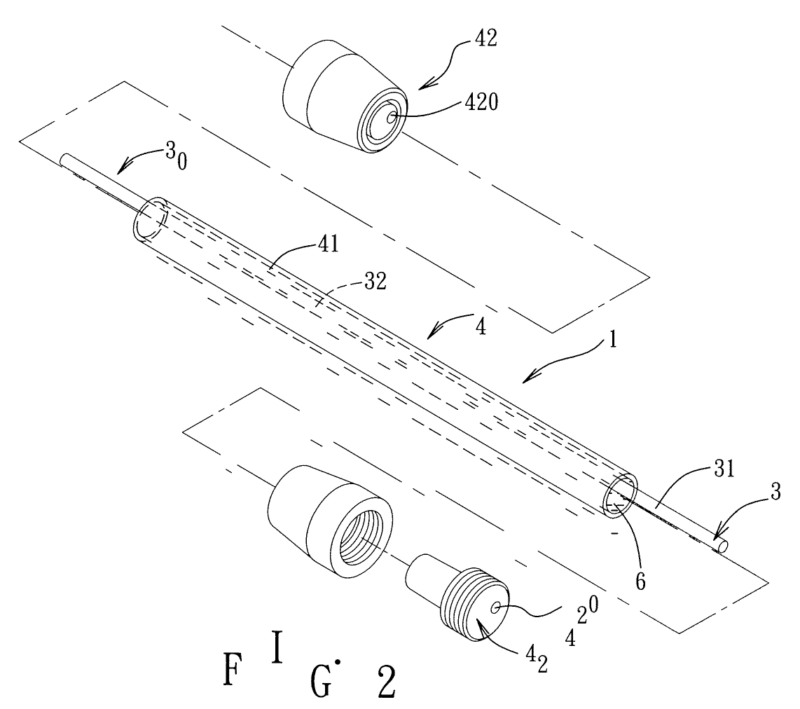

Referring to FIGS. 2 to 7, a heating device 1 according to the first preferred embodiment of the present invention includes a heat-conductive tube unit 3 that is adapted for passage of a heated fluid (such as hot water, hot oil or steam) therethrough and that has two opposite end portions 30, 31 and a middle portion 32 extending between the end portions 30, 31, a phase-change material 6 that encloses the middle portion 32 of the heat-conductive tube unit 3 and that is capable of storing heat through phase changing, and an enclosure 4 that encloses the phase-change material 6 for preventing leakage of the phase-change material 6.

In the first preferred embodiment, the enclosure 4 includes a sleeve 41 and a pair of end caps 42. The phase-change material 6 fills the sleeve 41. The end caps 42 sealingly cap two ends of the sleeve 41 and are formed with holes 420 for extension of the end portions 30, 31 of the heat-conductive tube unit 3 therethrough, respectively.

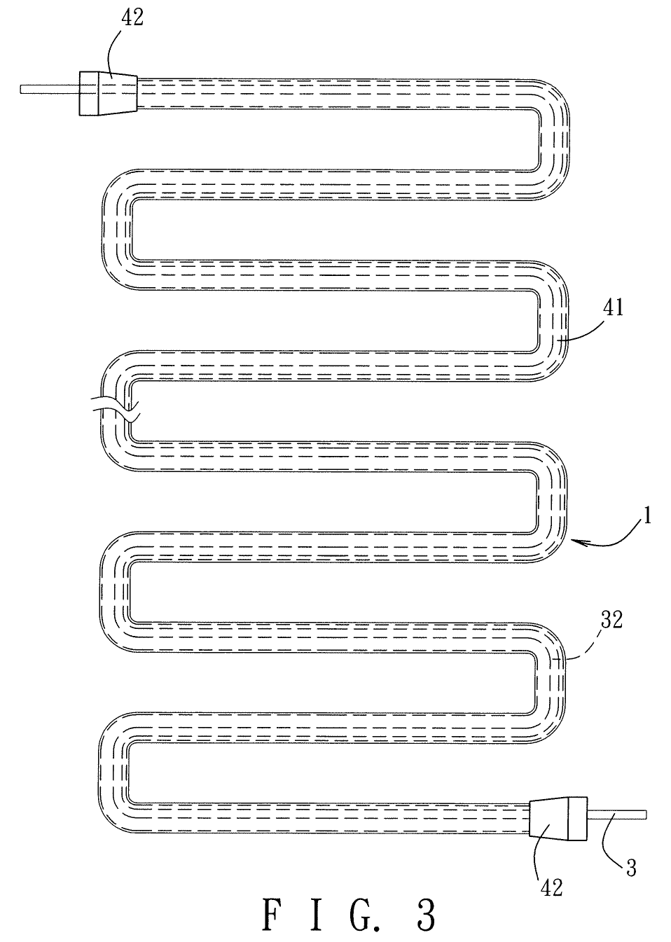

The sleeve 41 and the heat-conductive tube unit 3 are bendable so as to allow for reversible reshaping of the heating device 1. Preferably, the sleeve 41 is made of a flexible material, and the heat-conductive tube unit 3 is made of a flexible metal material. As such, the heating device 1 may be bent in a shape to suit the particular needs of a user. As an example, with reference to FIG. 3, the sleeve 41 and the middle portion 32 of the heat-conductive tube unit 3 of the heating device 1 are arranged in a meandering configuration to enable the heating device 1 to cover a relatively large area.

Additionally, the end caps 2 are fabricated from the same flexible material as the enclosure 4. Further, the hole 20 in one of the end caps 2 is aligned with the hole 20 in the other of the end caps 2 so as to allow the heat-conductive tube unit 3 to extend approximately in a straight line through the sleeve 41 (prior to any bending thereof). The holes 20 are packed with a waterproof material to prevent leakage of the phase-change material 6.

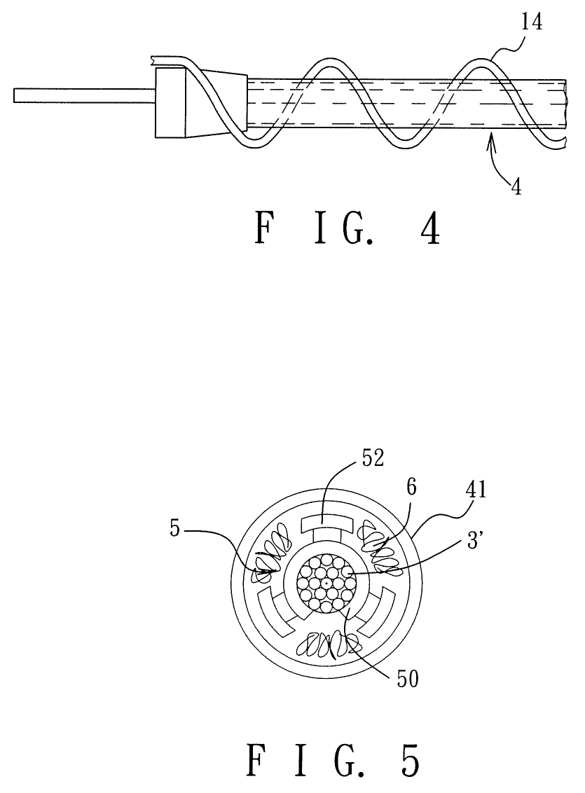

Moreover, with reference to FIG. 4, in the first preferred embodiment, a temperature sensor 14 is mounted on the enclosure 4 of the heating device 1, and is used to monitor the temperature of the heating device 1. Temperature information from the temperature sensor 14 is provided to the source (not shown) of the heated fluid such that the source can act accordingly, such as controlling the temperature of the heated fluid supplied to the heat-conductive tube unit 3 of the heating device 1 or stopping supply of the heated fluid to the heat-conductive tube unit 3, based on the temperature information received from the temperature sensor 14.

Additionally, in the first preferred embodiment, the heat-conductive tube unit 3 could include a single metal tube (see FIG. 2) or a bundle of metal tubes 3′ (see FIG. 5). With particular reference to FIG. 5, a tube support 5 is disposed in the sleeve 41. The tube support 5 includes a C-shaped ring member 50 for holding the metal tubes 3′ of the heat-conductive tube unit 3 therein, and a plurality of protrusions 52 projecting outwardly from the ring member 50 and that are angularly displaced from each other. A plurality of the tube supports 5 may be disposed in the sleeve 41 to provide full support to the heat-conductive tube unit 3.

If the heating device 1 is of any considerable length, the heat-conductive tube unit 3 may shift downward to thereby contact the inner surface of the sleeve 41 by virtue of gravity acting on the heat-conductive tube unit 3. As a result, heat is not uniformly distributed within the enclosure 4. The tube support 5 disposed inside the sleeve 41 prevents the heat-conductive tube unit 3 from contacting the inner surface of the sleeve 41. By providing a plurality of the tube supports 5 in the sleeve 41 as described above, the heat-conductive tube unit 3 is more fully supported to better prevent the same from contacting the inner surface of the sleeve 41.

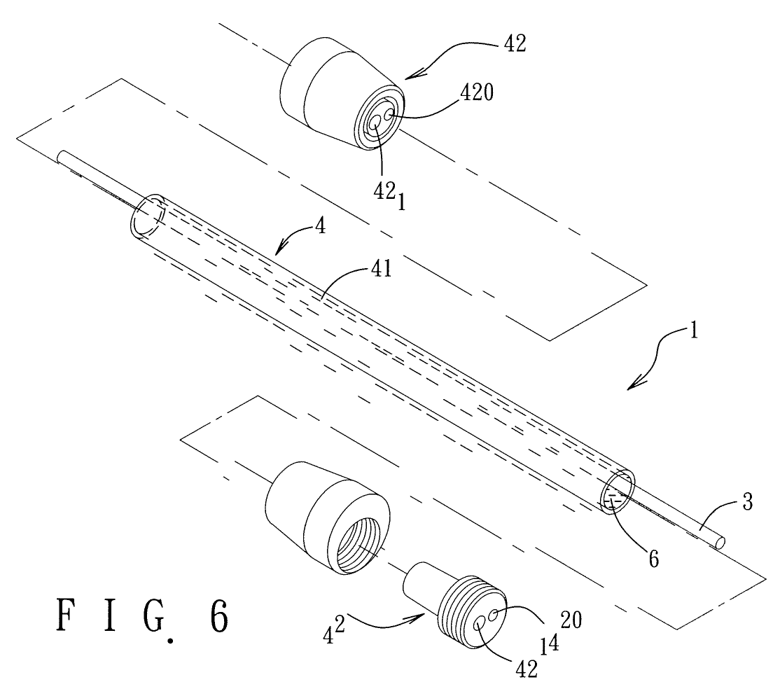

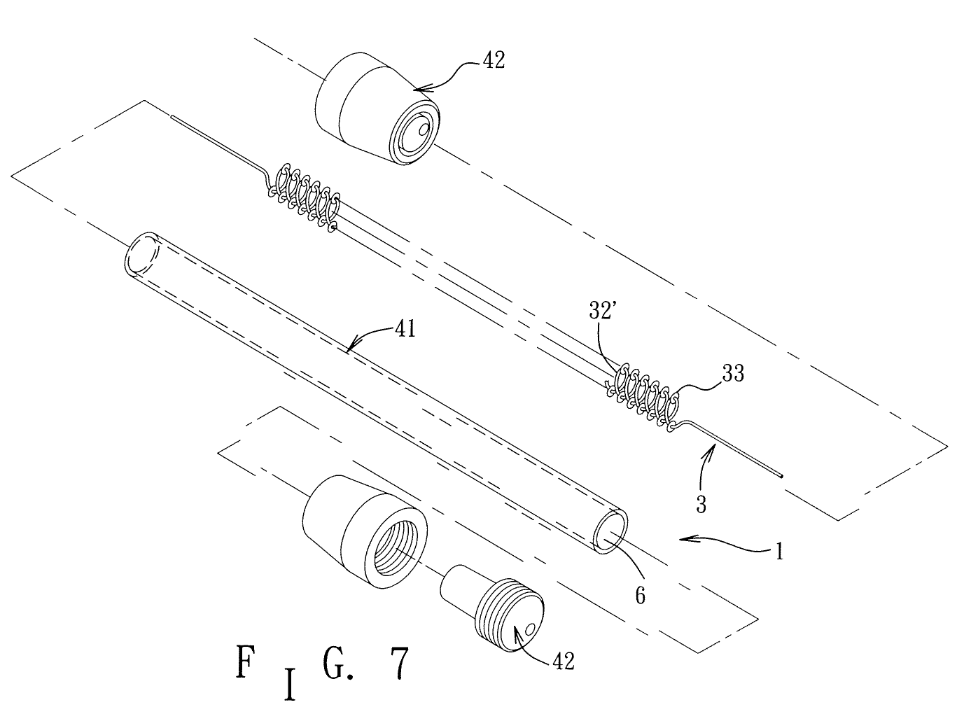

FIG. 6 illustrates a modified example of the first preferred embodiment of the heating device 1 according to the present invention. In this modified example of the first preferred embodiment, each of the end caps 42 is further formed with a second hole 421 through which the phase-change material 6 may be filled into the enclosure 4. After the phase-change material 6 fills the enclosure 4, the second holes 421 are packed with waterproof material.

It should be noted that the middle portion of the heat-conductive tube unit 3 is not limited to having a linear shape in other embodiments of the invention. Referring to FIG. 7, in another modified example of the first preferred embodiment of the heating device according to the present invention, the middle portion 32′ of the heat-conductive tube unit 3 is shown to be coil-shaped and is provided with a plurality of fins 33 that protrude outwardly thereon.

In operation, heated fluid (e.g., hot water, hot oil or steam) is supplied to the heat-conductive tube unit 3 so that the heat-conductive tube unit 3 radiates heat. The phase-change material 6 absorbs the heat and therefore, undergoes a change in phase so as to better store the heat. This stored heat is then released from the phase-change material 6.

It is to be noted that in some embodiments, the phase-change material 6 may be omitted from the configuration of the heating device 1. In this case, the heating device 1 is still operable to emit heat, albeit in a manner less efficient than that when the phase-change material 6 is filled in the enclosure 4.

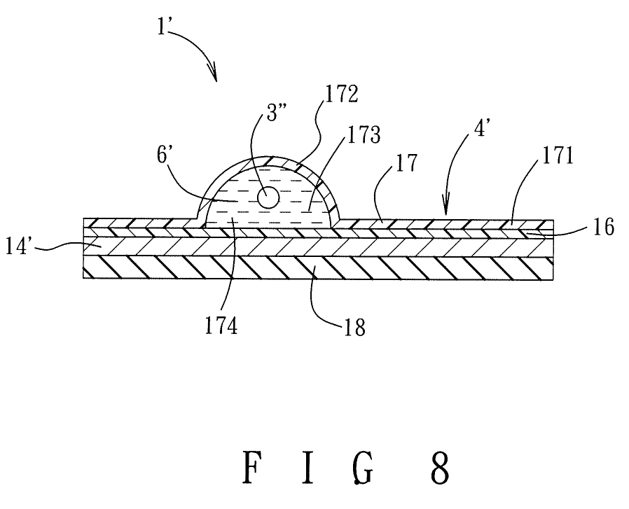

FIG. 8 illustrates the second preferred embodiment of the heating device 1′ of the present invention. In the second preferred embodiment, the enclosure 4′ includes a first layer 17 having a planar portion 171 and a protruding portion 172 protruding from the planar portion 171. The protruding portion 172 defines a groove 173 that has an open end 174. The enclosure 4′ further includes a second layer 16 that is attached to the first layer 17 so as to cover the open end 174 of the groove 173. The heat-conductive tube unit 3″ extends through the groove 173. The phase-change material 6′ fills the groove 173. Further, a protective layer 18 is attached to the second layer 16, and the temperature sensor 14′ is sandwiched between the protective layer 18 and the second layer 16. Preferably, the groove 173 and the middle portion of the heat-conductive tube unit 3″ are meandering in shape.

In this embodiment, the heating device 1′ can be provided on a piece of clothing (not shown) of the user, such as a jacket. When the heating device 1′ is used for such an application, the protective layer 18 is exposed to the environment, while the heat-conductive tube unit 3″ is proximate to the user's body. Because of this arrangement, the protective layer 18 can insulate the heating device 1′ from the cold environment while the heat-conductive tube unit 3″ radiates heat towards the user's body.

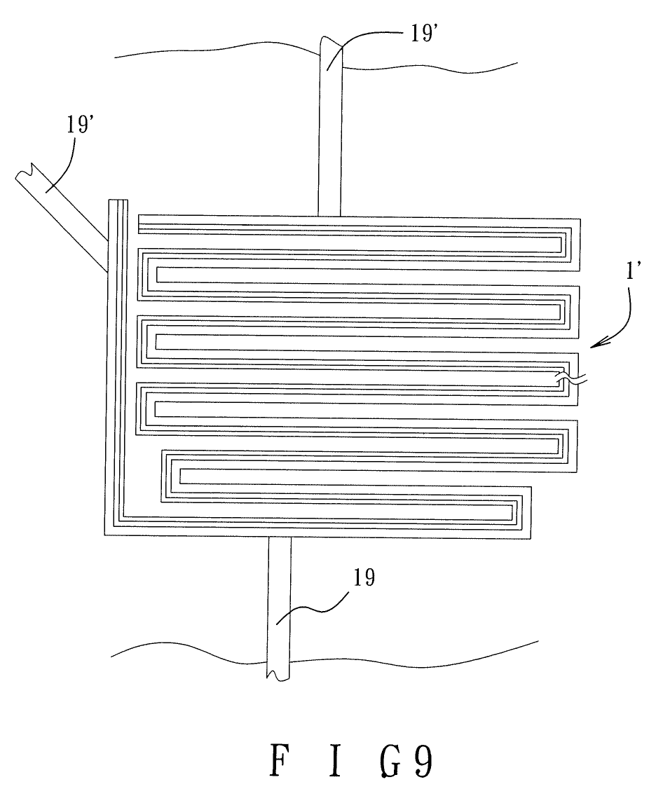

Reference is now made to FIG. 9, which illustrates an exemplary layout of the heating device 1′ in accordance with the second preferred embodiment. This exemplary layout of the heating device 1′ is realized by forming the groove 173 in a meandering shape. The phase-change material 6′ is supplied to fill the groove 173 through an inlet tube 19, and at least one outlet tube 19′ may be provided on the heating device 1′ so as to discharge air bubbles.

It is to be noted that if any one of the temperature sensor 14′, the protective layer 18, and the phase-change material 6′ is not included as part of the second preferred embodiment, the heating device 1′ will nevertheless remain operable.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A heating device comprising:
a heat-conductive tube unit adapted for passage of a heated fluid therethrough and having two opposite end portions and a middle portion extending between said end portions;
a phase-change material enclosing said middle portion of said heat-conductive tube unit and capable of storing heat through phase changing; and
an enclosure enclosing said phase-change material for preventing leakage of said phase-change material.

2. The heating device as claimed in claim 1, wherein said enclosure includes a sleeve and a pair of end caps, said phase-change material filling said sleeve, said end caps capping two ends of said sleeve and being formed with holes for extension of said end portions of said heat-conductive tube unit therethrough, respectively.

3. The heating device as claimed in claim 2, wherein said sleeve and said heat-conductive tube unit are bendable so as to allow for reversible reshaping of said heating device.

4. The heating device as claimed in claim 3, wherein said sleeve and said middle portion of said heat-conductive tube unit are meandering in shape.

5. The heating device as claimed in claim 1, further comprising a temperature sensor mounted on said enclosure.

6. The heating device as claimed in claim 1, wherein said heat-conductive tube includes at least one metal tube.

7. The heating device as claimed in claim 2, further comprising a tube support disposed in said sleeve and including a ring member for holding said heat-conductive tube unit therein, and a plurality of protrusions projecting outwardly from said ring member and being angularly displaced from each other.

8. The heating device as claimed in claim 1, wherein said middle portion of said heat-conductive tube unit is coil-shaped.

9. The heating device as claimed in claim 8, wherein said middle portion of said heat-conductive tube unit is provided with a plurality of fins that protrude outwardly thereon.

10. The heating device as claimed in claim 1, wherein said enclosure includes a first layer having a planar portion and a protruding portion protruding from said planar portion and defining a groove that has an open end, said enclosure further including a second layer attached to said first layer to cover said open end of said groove, said heat-conductive tube unit extending through said groove, said phase-change material filling said groove.

11. The heating device as claimed in claim 10, further comprising a protective layer attached to said second layer, and a temperature sensor sandwiched between said protective layer and said second layer.

12. The heating device as claimed in claim 10, wherein said groove and said middle portion of said heat-conductive tube unit are meandering in shape.

13. A heating device comprising:
a heat-conductive tube unit having two opposite end portions and a middle portion extending between said end portions; and
an enclosure including a sleeve and a pair of end caps, said end caps capping two ends of said sleeve and being formed with holes for extension of said end portions of said heat-conductive tube unit therethrough, respectively.

14. The heating device as claimed in claim 13, wherein said sleeve and said heat-conductive tube unit are bendable so as to allow for reversible reshaping of said heating device.
